(19) United States
(12) Patent Application Publication
(10) Pub. No.: US 2006/0086869 A1
(43) Pub. Date: Apr. 27, 2006

(54) Tripod for a musical instrument

(76) Inventor: Wu-Hong Hsieh, Lu Chou City (TW)

Correspondence Address: BACON & THOMAS, PLLC, 625 SLATERS LANE, FOURTH FLOOR, ALEXANDRIA, VA, 22314, US

(21) Appl. No.: 10/972,393

(22) Filed: Oct. 26, 2004

(51) Int. Cl. F16M 11/38

(52) U.S. Cl. 248/171

(57) ABSTRACT

A tripod has a central post, a primary post lock, a secondary post lock, three legs and three extension arms. The central post has an upper end and a lower end. The primary and secondary post locks are selectively mounted around the central post. The legs are pivotally attached to the primary post lock. The extension arms are pivotally attached to the legs and the secondary post lock. The tripod can be configured with the secondary post lock at the lower end of the central post to form a standing tripod or the primary post at the lower end of the central post for form a level tripod or a standing tripod.

### BACKGROUND OF THE INVENTION

1. Field of the Invention

The present invention relates to a tripod, especially to a tripod for a musical instrument.

2. Description of the Prior Arts

A musical instrument such as a cymbal, a drum or a keyboard is usually mounted on a tripod when the musical instrument is played. The tripod holds a musical instrument at an appropriate height for people to play the musical instrument. Conventional tripods generally are standing or level.

A level tripod comprises a central post and three supports. The central post has an upper end and a lower end. The musical instrument is mounted on the upper end of the central post. The supports are mounted radially on the lower end of the central post hold the central post vertical and contact the ground.

With reference to FIGS. 8 and 9, a standing tripod comprises a central post (80), a post lock (82), three legs (81), a stationary bracket (83) and three extension arms (84). The central post (80) has an upper end and a lower end. The musical instrument is mounted on the upper end of the central post (80). The post lock (82) is mounted slidably around the central post (80) and has an outer surface and a locking device (821). The legs (81) are connected pivotally to the outer surface of the post lock (82). The stationary bracket (83) is connected to the lower end of the central post (80) and has an outer surface. Each extension arm (84) has an inner end and an outer end. The inner ends of the extension arms (84) are connected pivotally to the outer surface of the stationary sleeve (83), and the outer ends of the extension arms (84) are connected pivotally to the legs (81). Since the post lock (82) slides on the central post (80), the legs (81) and extension arms (84) can be moved to adjust the height of the tripod. Then the locking device (821) engages and holds the post lock (82).

Because the supports of the level tripod abut the ground, the level tripod will be stable on an even surface but may be unstable on a rough or uneven surface. On the contrary, the standing tripod will be more stable on rough and uneven surfaces but less stable on even surfaces. To make a musical instrument stable on any surface, a user must prepare both the level tripod and the standing tripod.

To overcome the shortcomings, the present invention provides a tripod for a musical instrument to mitigate or obviate the aforementioned problems.

### SUMMARY OF THE INVENTION

The main objective of the present invention is to provide a tripod that can be used on any and will always be stable.

The tripod in accordance with the present invention comprises a central post, a primary post lock, a secondary post lock, three legs and three extension arms. The central post has an upper end and a lower end. The primary and secondary post locks are selectively mounted around the central post. The legs are attached pivotally to the primary post lock. The extension arms are attached pivotally to the legs and the secondary post lock. The central post can be removed from the primary and secondary post locks to reconfigure or store the tripod. The tripod can be a standing tripod or a level tripod by changing the sequence that the lower end of the central post passes through the primary and secondary post locks.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tripod for a musical instrument in accordance with the present invention configured as a standing tripod;

FIG. 2 is an exploded perspective view of the tripod in FIG. 1;

FIG. 3 is a side view in partial section of the tripod in FIG. 1;

FIG. 4 is a perspective view of the tripod in FIG. 1 configured as a level tripod;

FIG. 5 is a side view in partial section of the tripod in FIG. 4;

FIG. 6 is a perspective view of the tripod in FIG. 1 configured to hold a

heavy musical instrument;

FIG. 7 is a side view in partial section of the tripod in FIG. 6;

FIG. 8 is a perspective view of a conventional standing tripod in

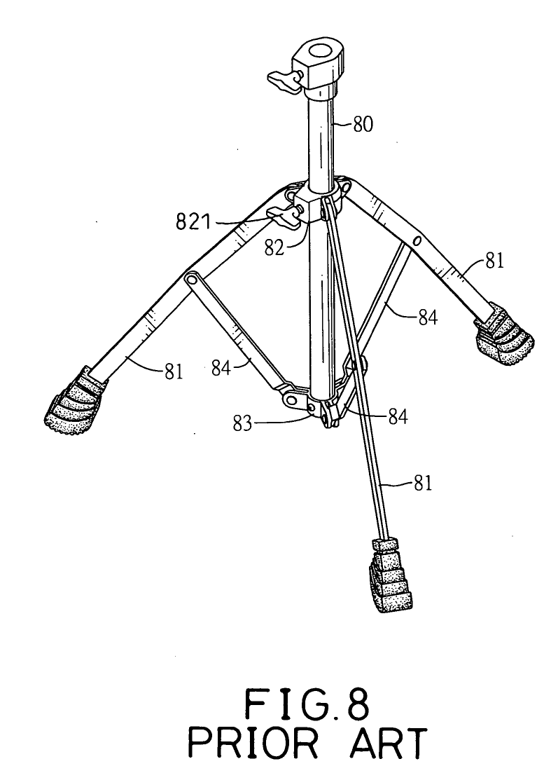

accordance with the prior art; and

FIG. 9 is a side view in partial section of the standing tripod in FIG. 8.

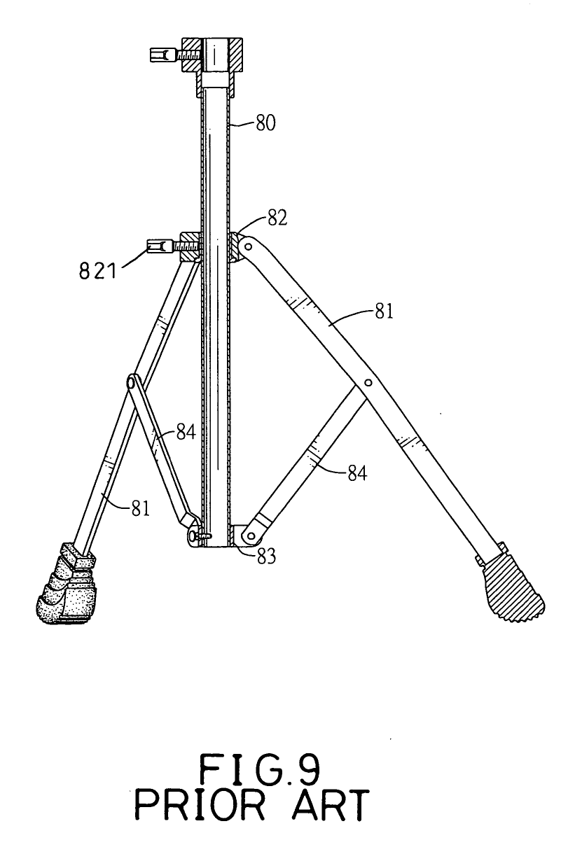

### DETAILED DESCRIPTION OF THE PREFERRED EMBODIMENTS

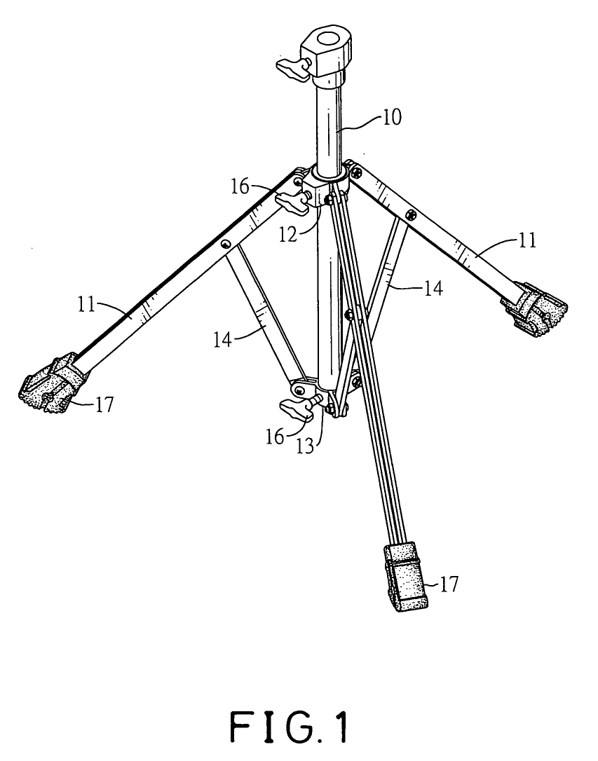

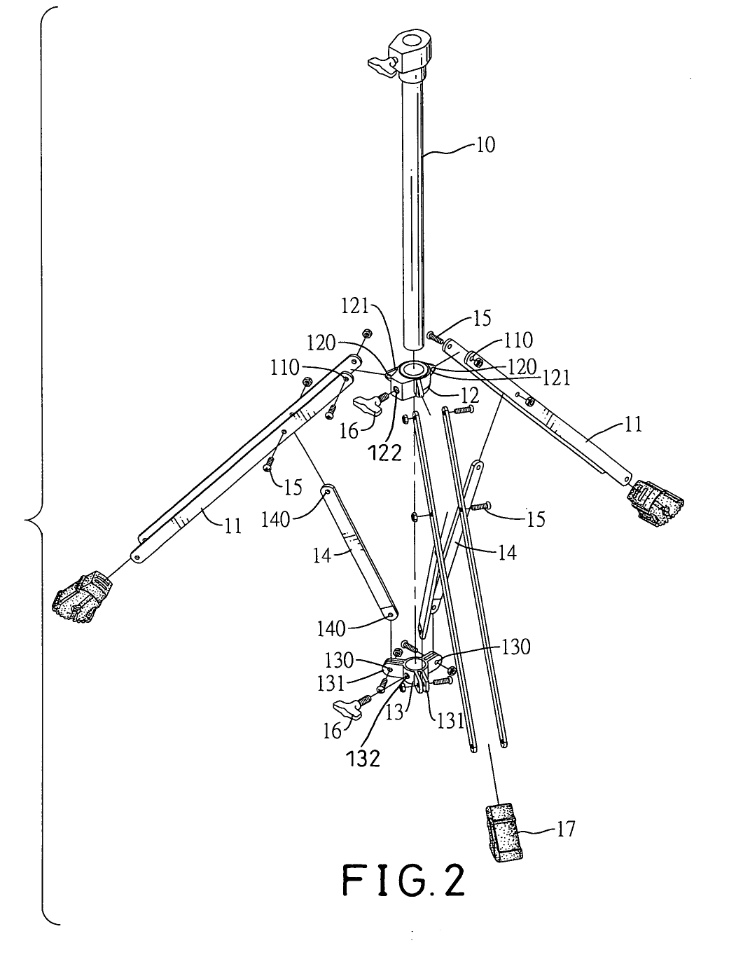

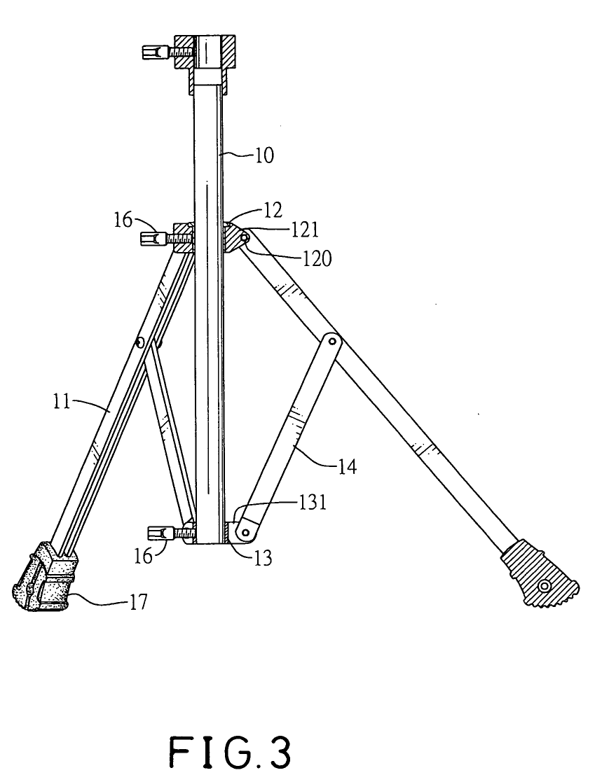

With reference to FIGS. 1, 2 and 3, a tripod for a musical instrument in accordance with the present invention comprises a central post (10), a primary post lock (12), a secondary post lock (13), two locking actuators, three legs (11), three optional non-slip feet (17), three extension arms (14) and multiple optional fasteners (15). The tripod can be configured selectively as a standing tripod or a level tripod.

The central post (10) has an upper end and a lower end. A musical instrument is mounted on the upper end of the central post (10).

The primary post lock (12) is mounted selectively around the central post (10) and has an inner surface, an outer surface, three pivot attachment devices and a lock-actuating hole. The pivot attachment devices are formed on the outer surface of the primary post lock (12) and can be implemented as pivot ears (121), pairs of pivot wings, seats for pivot balls or any other conventional pivotal connection. When the pivot attachment devices are pivot ears (121), pivot wings or the like, the pivot attachment devices respectively have pivot holes (120). The pivot holes (120) are transversely formed respectively through the pivot attachment devices. The lock-actuating hole is formed radially from the outer surface to the inner surface of the primary post lock (12) and may be a threaded hole (122).

The secondary post lock (13) is mounted selectively around the central post (10) and has an inner surface, an outer surface, three pivot attachment devices and a lock-actuating hole. The pivot attachment devices are formed on the outer surface of the secondary post lock (13) and can be implemented as pivot ears, pairs of pivot wings (131), clamping seats for pivot balls or any other conventional pivotal connection. When the pivot attachment devices are pairs of pivot wings (131), pivot ears or the like, the pivot attachment devices respectively have pivot holes (130). The pivot holes (130) are transversely formed respectively through the pairs of pivot wings (131), the pivot ears or the like. The lock-actuating hole is formed radially from the outer surface to the inner surface of the secondary post lock (13) and may be a threaded hole (132).

The locking actuators mounted respectively in the lock actuating holes in the primary and secondary post lock (12,13) and may be implemented with thumbscrews (16), eccentric levers or other conventional devices to actuate a lock. When the locking actuators are thumbscrews (16), the thumbscrews (16) are screwed respectively into the threaded holes (122, 132) in the primary and secondary post locks (12, 13) as setscrews to selectively grip and hold the central post (10) and attach the primary and secondary post locks (12, 13) to the central post (10) in selected positions.

The legs (11) are connected pivotally to the primary post lock (12), and each leg (11) has a proximal end, a distal end, a proximal pivot connector and a medial pivot connector. The proximal pivot connectors are formed respectively in the proximal ends of the legs (11) and correspond respectively to the pivot attachment devices on the primary post lock (12). The medial pivot connectors are formed respectively between proximal ends and distal ends of the legs (11). The pivot connectors may be implemented as pivot holes (110, 111), pivot balls or any other conventional pivot connector.

The non-slip feet (17) are attached respectively to the distal ends of the legs (11).

The extension arms (14) are attached pivotally to the legs (11) and the secondary post lock (13), and each extension arm (14) has an inner end and an outer end. The inner and outer ends have pivot connectors connected and corresponding respectively to the pivot attachment devices on the secondary post lock (13) and the medial pivot connectors on the legs (11). The pivot connectors may be pivot holes (140) or pivot balls.

The fasteners (15) are used in conjunction with and mounted in the pivot holes (110, 111, 120, 130, 140) to pivotally attach the legs (11) to the primary post lock (12), the extension arms (14) to the secondary post lock (13) and the extension arms (14) to the legs (11).

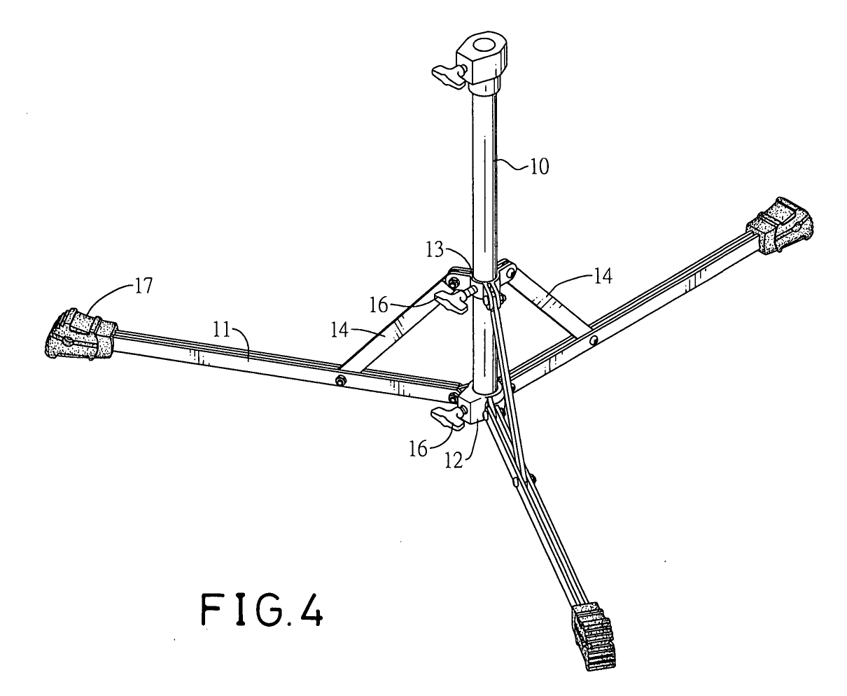

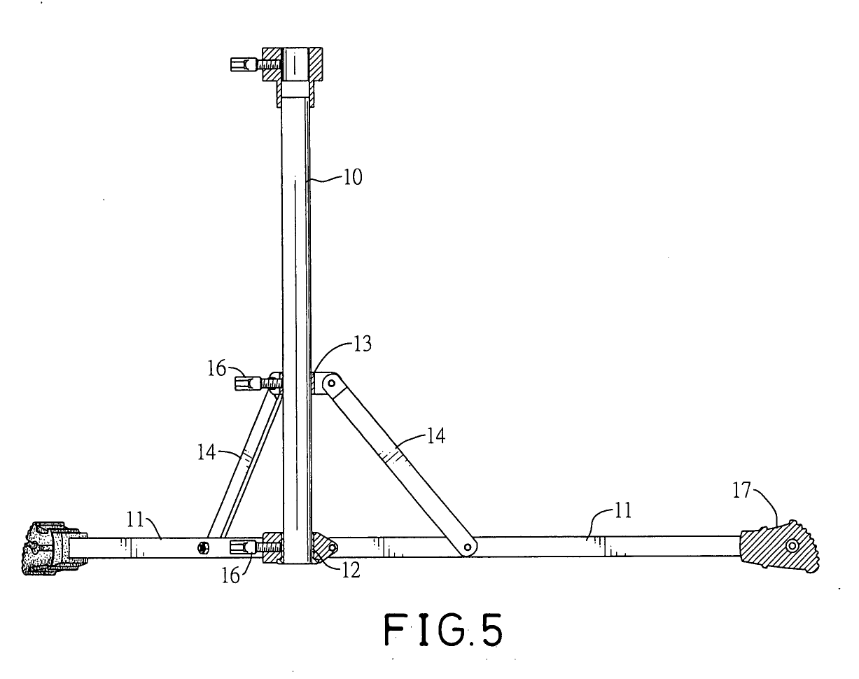

With further reference to FIGS. 4 and 5, the level tripod is formed by securely attaching the primary post lock (12) around the lower end of the central post (10). The secondary post lock (13) is mounted around the central post (10) above the primary post lock (12) in a position so the legs (11) extend perpendicular from the central post (10).

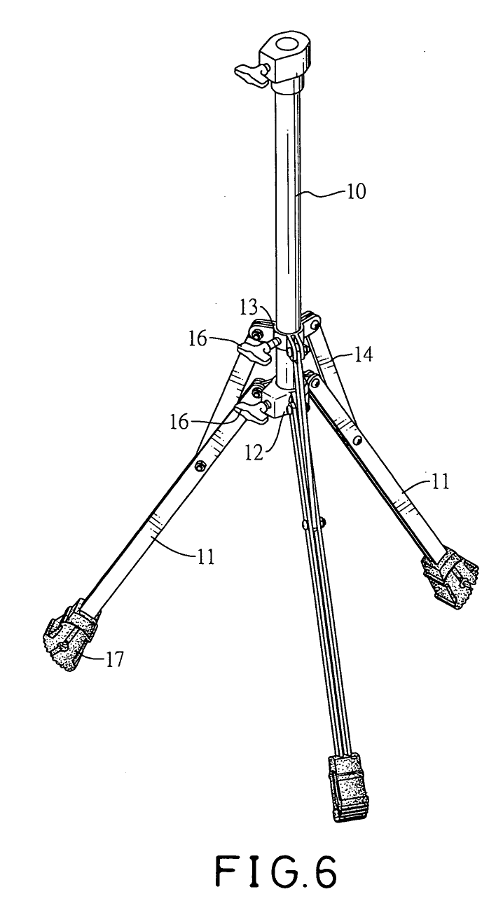

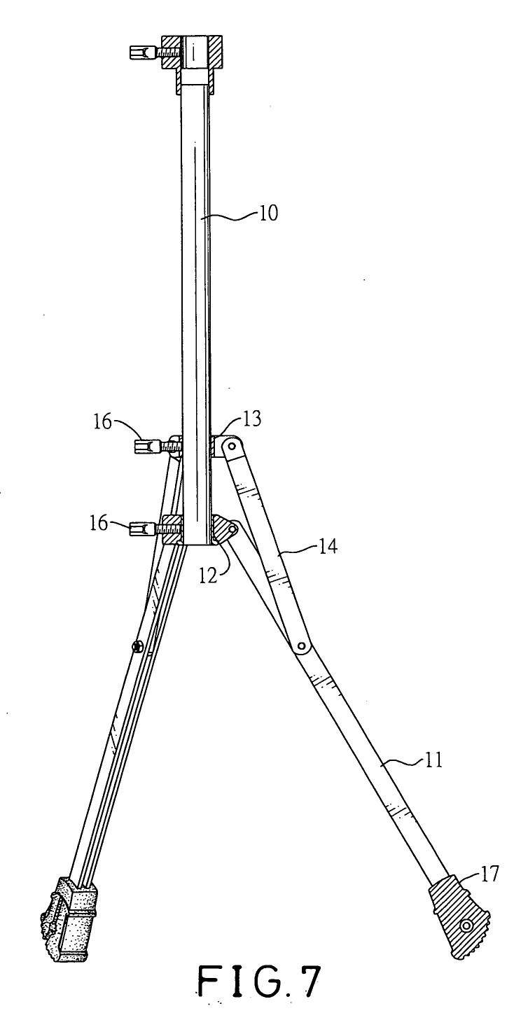

With further reference to FIGS. 6 and 7, the secondary post lock (13) is moved toward the primary post lock (12) until the legs (11) extend down from the central post (10) and is attached securely around the central post (10).

The tripod as described has numerous advantages. The post locks (12, 13) can be removed from the central post (10) quickly and quickly mounted around the central post (10) to change the tripod to either a standing tripod or a level tripod. Therefore the tripod will be stable on an even or uneven surface. The extension arms (14) can strengthen the central post (10). Therefore the tripod can hold heavy musical instrument.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tripod for a musical instrument comprising
a central post having
an upper end; and
a lower end;
a primary post lock selectively mounted around the central post and having
an inner surface;
an outer surface;
three pivot attachment devices formed on the outer surface; and
a lock-actuating hole formed radially from the outer surface to the inner surface of the primary post lock;
a secondary post lock selectively mounted around the central post and having
an inner surface;
an outer surface;
three pivot attachment devices formed on the outer surface of the secondary post lock; and
a lock-actuating hole formed radially from the outer surface to the inner surface of the secondary post lock;
two locking actuators mounted respectively in the lock actuating holes in the primary and secondary post locks;
three legs connected pivotally to the primary post lock, and each leg having
a proximal end;
a distal end;
a proximal pivot connector formed in the proximal end and corresponding to one of the pivot attachment devices on the primary post lock; and
a medial pivot connector formed between the proximal end and the distal end;
three extension arms attached pivotally to the legs and the secondary post lock, and each secondary support having
an inner end connected and corresponding to one of the pivot attachment devices on the secondary post lock: and
an outer end connected and corresponding to the medial pivot connector on a corresponding one of the legs.

2. The tripod as claimed in claim 1, wherein the pivot attachment devices on the primary post lock are ears having pivot holes transversely formed respectively through the ears.

3. The tripod as claimed in claim 1, wherein the lock-actuating hole in the primary post lock is a threaded hole and the locking actuator is a thumbscrew.

4. The tripod as claimed in claim 1, wherein the lock-actuating hole in the secondary post lock is a threaded hole and the locking actuator is a thumbscrew.

5. The tripod as claimed in claim 1, wherein the medial pivot connectors on the legs are pivot holes.

6. The tripod as claimed in claim 1 further comprising three non-slip blocks mounted on the distal ends of the legs.

7. The tripod as claimed in claim 1, wherein the secondary post lock is attached to the lower end of the central post.

8. The tripod as claimed in claim 1, wherein the primary post lock is attached to the lower end of the central post.

9. The tripod as claimed in claim 2, wherein the proximal pivot connector on each leg is pairs of pivot wings having pivot holes transversely formed respectively through the pivot wings and are connected respectively to the ears of the primary post lock with fasteners.
